(19) United States
(12) Patent Application Publication
(10) Pub. No.: US 2011/0149468 A1
(43) Pub. Date: Jun. 23, 2011

(54) THREE-DIMENSIONAL CAPACITOR AND TOPOLOGICAL DESIGN METHOD FOR SUCH A CAPACITOR

(75) Inventors: Eric Picollet, La Ferriere (FR); Claire Deglise-Favre, Chanbery (FR); Remi Magand, Saint Hilaire (FR)

(73) Assignee: STMICROELECTRONICS S.A., Montrouge (FR)

(21) Appl. No.: 13/060,152

(22) PCT Filed: Aug. 24, 2009
(86) PCT No.: PCT/FR2009/051620

§ 371 Date: Mar. 9, 2011

(30) Foreign Application Priority Data
Aug. 27, 2008 (FR) 0855745

(51) Int. Cl. H01G 4/228; G06F 17/50

(52) U.S. Cl. 361/306.3; 703/1

(57) ABSTRACT

A three-dimensional capacitor is formed from a multilayer of superposed electrodes. The electrodes are formed within respective metallization levels of an integrated circuit. At least two additional superposed electrodes are formed on top of the multilayer. Each additional electrode is formed from a branched rectilinear structure including at least one bar aligned in a first direction and a plurality of branches extending from that at least one bar in a second direction.

### PRIORITY CLAIM

The present application is a 371 filing from PCT/FR2009/051620 filed Aug. 24, 2009 which claims the benefit of French Application for Patent No. 08-55745 filed Aug. 27, 2008, the disclosures of which are hereby incorporated by reference.

### TECHNICAL FIELD

The invention relates, generally speaking, to the design and the fabrication of capacitors, in particular for high-frequency applications. It relates more particularly to the design and the fabrication of three-dimensional capacitors designed to be installed onto a semiconductor substrate, notably using a MOM (Metal-Oxide-Metal) protocol.

One particularly advantageous application relates to the design of MOM capacitors for high-frequency applications using CMOS045 technology, in other words a technology using a 45 nanometer etch resolution. However, the invention is also generally applicable to the design of three-dimensional capacitors that may use any other CMOS technology, or even technologies using an etch resolution of 32 nanometers.

### BACKGROUND

Three-dimensional capacitors exhibit a certain number of advantages with respect to planar capacitors. In particular, they allow capacitors to be integrated with a greater density and therefore with a high value of capacitance per unit surface area, while at the same time exhibiting a low access resistance and a high and stable quality factor.

Three-dimensional capacitors, also referred to as “3D” capacitors, are conventionally fabricated by forming electrodes distributed over several metallization levels. For example, in CMOS045 technology, a 3D capacitor can be formed using seven levels of metallization within which respective electrodes of the capacitor are formed, pairs of which form an assembly of elementary capacitors.

As illustrated in FIG. 1, which illustrates the organization of the electrodes within lower metallization levels, the electrodes each comprise an assembly of bars or fingers aligned in parallel but oriented alternately in the stack along two perpendicular directions forming, with a bar facing the same electrode and with a bar of a lower or upper electrode, elementary capacitors.

More particularly, as can be seen in FIGS. 1 and 2, each metallization level, such as Mᵢ, comprises an electrode Eᵢ formed by the association of two interleaved combs P₁ and P₂, each comprising an assembly of bars B extending in parallel in a first general direction from an end lateral bar B′, whereas within another metallization level lying immediately above or below, the bars B of the comb are aligned in a second direction perpendicular to the first direction.

In addition, according to this configuration, the bars of each comb of one metallization level Mᵢ, which form a positive or negative electrode, are connected to the bars of another metallization level M′ᵢ which form electrodes, positive or negative respectively, by means of vias such as V.

Furthermore, with the aim of enhancing the electrical functionalities of the capacitor, the upper metallization levels, here the metallization levels M₆ and M₇, have a specific configuration and, in particular, a different scale factor, the size of the bars and the thickness of these electrodes being greater in these metallization levels M₆ and M₇.

As can be seen, the electrodes of the metallization levels M₆ and M₇ have an identical configuration and comprise two interleaved combs P₁ and P₂ formed from an association of parallel bars and also having the same orientation within both the metallization level M₆ and the metallization level M₇.

Furthermore, the designers of passive electronic components, and in particular of three-dimensional capacitors, must, based on design rules imposed on them, for example relating to the technology employed or to the constraints of the circuit to be fabricated, relating for example to the value of capacitance to be obtained or to the connection of the capacitor, design a capacitor configuration allowing the required electrical functionalities to be obtained, while at the same time limiting the consumption of silicon which is a very costly material.

### SUMMARY

In view of the above, according to the present description, a three-dimensional capacitor architecture and a design method for such a capacitor are provided that allow, according to the imposed design rules, a capacitor to be produced that leads to further improvements in the electrical functionalities delivered.

According to a first subject, a three-dimensional capacitor comprises a multilayer of superposed electrodes formed within respective metallization levels of an integrated circuit also comprising at least two additional superposed electrodes formed on top of the multilayer, the additional electrodes each comprising an assembly of at least one bar aligned in a first direction, at least one part of the bars comprising branches extending in a second direction.

It has been observed that such a structure, according to which the bars situated, for example, in the center of the upper metallization levels of the electrode multilayer of the capacitor comprise transverse branches, allows the functionalities of the capacitor to be considerably improved and, in particular, an increase in the unitary capacitance to be obtained for the same surface area, together with a decrease in the access resistance for constant quality factor or, in other words, for constant equivalent capacitance and for constant equivalent access resistance, a significant reduction in the surface area of the capacitor, thus limiting the silicon consumption.

According to another feature of this capacitor, the branches are composed of fingers extending perpendicular to the bars.

In one embodiment, the additional electrodes comprise rectilinear non-branched end bars and branched central bars provided between the end bars.

The bars of one of the additional electrodes can be aligned parallel to the bars of the other additional electrode.

According to yet another feature of this three-dimensional capacitor, the bars of each additional electrode comprise a pair of identical matched and interleaved patterns each comprising a first assembly of at least one bar aligned parallel to each bar of another pattern in the first direction and a second assembly of at least one bar aligned parallel to the bars of the second assembly of bars of the other pattern in the second direction.

The branches can furthermore extend from the central bars of the first assembly of bars.

The bars of the first assembly of bars themselves can be formed from one of the bars of the second assembly of bars.

According to yet another feature of the three-dimensional capacitor, the electrodes of the multilayer of electrodes each comprise a pair of identical and interleaved patterns each comprising a first assembly of bars aligned parallel to each bar of another pattern in one of the first or second directions, and a second assembly of second bars aligned parallel to each second bar of the other pattern in the other of the first or second directions.

The patterns of each electrode of the multilayer can be oriented in a direction different from that of the patterns of an electrode immediately above or below.

According to a second subject, the invention also provides a design method for a three-dimensional capacitor comprising a multilayer of superposed electrodes formed within respective metallization levels of an integrated circuit, and comprising at least two additional superposed electrodes formed on top of the multilayer in such a manner that the additional electrodes each comprise an assembly of at least one bar aligned in a first direction and that at least one part of the bars comprises branches extending in a second direction.

According to one feature of this method, a number of bars is calculated for each additional electrode, the available distance for the branches is calculated, and the number of bars is adapted in such a manner as to obtain an available length for the branches greater than a minimum distance required between the bars.

In other words, the number of bars is adapted in such a manner as to create, for example in the center of the electrode, a sufficient distance between bars in order to accommodate the branches, taking into account the minimum distance required between the bars and, in particular, between the branches and an opposing bar in order to satisfy the demands required, in particular by the design rules.

For example, according to another feature of this method, the number of branches is determined based on the length of the bars, on the width of the branches and on the spacing between neighboring branches, and the length of the branches is determined based on the distance between the bars and on the minimum spacing required between the bars.

For example, according to one embodiment, the width of the branches is set equal to the width of the bars.

In one embodiment, the method comprises the steps for: calculating the number of bars as a function of the width of the bars and of the spacing between the bars; calculating the spacing between the branched bars; comparing the spacing calculated with a minimum value of spacing required between a branch and a neighboring branched bar; and modifying the number of bars calculated in such a manner as to obtain a spacing value greater than the minimum required value.

This method may also comprise a step for adapting the spacing between the bars prior to the calculation of the length of the branches.

The distance between two neighboring branches may also be calculated.

The bars may furthermore be oriented in such a manner as to obtain the greatest total length of the branches.

For example, for this purpose, the difference can be calculated between, on the one hand, the length of the branches for a first configuration in which the bars are aligned in a first direction, multiplied by the number of branches, and, on the other hand, the length of the branches for a second configuration in which the bars are aligned in a second direction perpendicular to the first direction, multiplied by the number of branches, and the first or the second configuration is chosen depending on the result of the calculation of the difference.

In an embodiment, an apparatus comprises: a metallization level of an integrated circuit, the metallization level being one of a multilayer structure defining a three-dimensional capacitor. The metallization level comprises: a first electrode; and a second electrode. Each of the first and second electrodes comprises a rectilinear branched structure including: a first set of branches extending in a first direction from a bar which extends in a second direction perpendicular to the first direction; and a second set of branches extending in the second direction from at least one of branch within the first set of branches.

### BRIEF DESCRIPTION OF THE DRAWINGS

Other aims, features and advantages of the invention will become apparent upon reading the following description, presented only by way of non-limiting example and with reference to the appended drawings:

FIGS. 1 and 2, which have already been mentioned, illustrate schematically the general architecture of a three-dimensional capacitor according to the prior art;

FIG. 3 illustrates a schematic perspective view of the architecture design of a three-dimensional capacitor comprising central branches;

FIG. 4 is a top view of the upper metallization level of the three-dimensional capacitor with branches in FIG. 3;

FIG. 5 illustrates schematically the design of a three-dimensional capacitor;

FIG. 6 shows the main phases of a method for designing a three-dimensional capacitor with lateral branches;

FIG. 7 is a top view of a three-dimensional capacitor with lateral branches showing the main parameters taken into consideration during the design;

FIGS. 8 to 16 show various configurations of a three-dimensional capacitor with lateral branches; and

FIG. 17 is a table showing the gains in capacitance, resistance and quality factor value by virtue of the presence of central lateral branches.

### DETAILED DESCRIPTION OF THE DRAWINGS

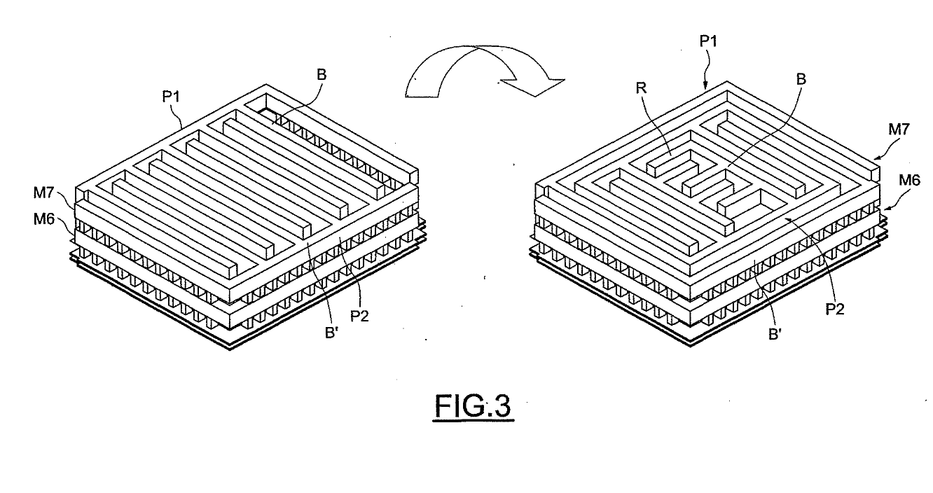

Referring firstly to FIG. 3, an exemplary embodiment of a three-dimensional MOM capacitor fabricated using 45 nanometer technology will be described.

As can be seen, in the example described, the three-dimensional capacitor here comprises seven metallization levels, the upper metallization levels M₆ and M₇ being configured in such a manner as to reduce the access resistance and to increase the value of capacitance for a given circuit surface area.

As previously indicated, conventional three-dimensional capacitors comprise an assembly of superposed electrodes distributed within metallization levels of the integrated circuit and, in the upper part, additional electrodes formed within the metallization levels M₆ and M₇. The upper metallization levels M₆ and M₇ have an identical interleaved comb configuration and orientation, in such a manner that each electrode comprises a pair of combs P₁ and P₂ each formed by an association of bars B extending in a first direction from a transverse bar B′ aligned in a second direction perpendicular to the first direction, such that the bars of one of the combs are interleaved between two bars of the other comb.

With the aim of improving the electrical performance of the capacitor, the electrodes of the upper metallization levels M₆ and M₇ are modified in such a manner that the bars situated in the center comprise lateral branches R which extend in parallel in the second direction, in other words parallel to the bars B′ from which the branched bars B extend. According to this configuration, the two central bars opposite the combs comprise interleaved branches such that the branches of one of the bars run between the branches R of the other bar.

In other words, according to this comb configuration, each comb comprises two assemblies of fingers or bars, namely a first assembly of parallel bars B, of which there are four here, which are aligned in an X or Y direction of the circuit, here the Y direction, and which comprise central branched bars, and a second assembly of bars B′, of which there is one here, from which the bars B extend and which are aligned in the other direction X.

Here, there are two branches from one of the bars which are each disposed between two branches of the other comb, of which there are three here.

However, it goes without saying, as will be detailed hereinbelow, that any other configuration may also be adopted.

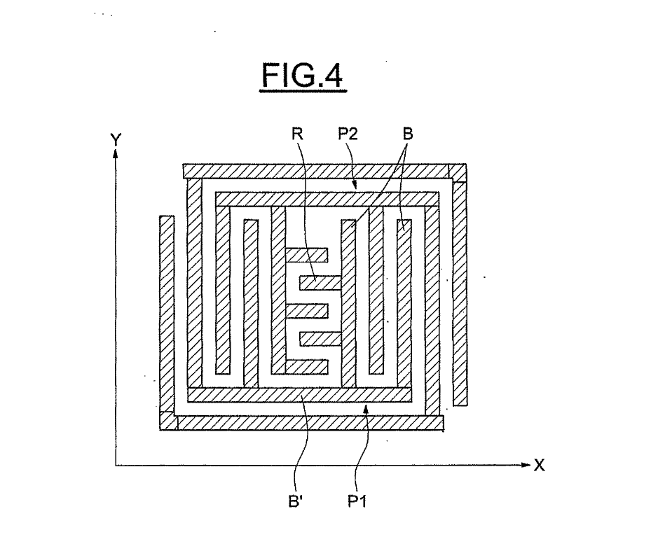

As can also be seen in FIG. 4, according to this configuration, only the metallization levels M₆ and M₇, which adopt an identical configuration and the same orientation, are modified, the lower metallization levels adopting a conventional configuration, in other words an interleaved comb configuration, in such a manner that, in the electrode multilayer, the orientations of the bars differ by 90° from one multilayer to the other.

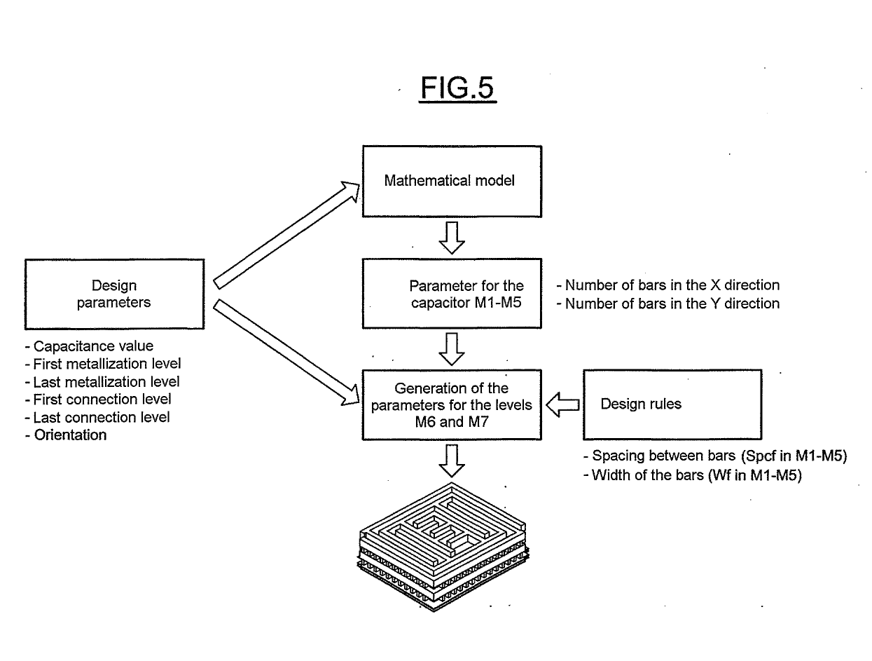

Referring to FIG. 5, the design of a three-dimensional capacitor with central lateral branches is carried out based on design parameters imposed on the designer, such as the value of the capacitance, the first metallization level from which the electrodes must be formed, the last metallization level, the first connection level for the capacitor in the integrated circuit, the last connection level and, where relevant, the planar dimensions (in X,Y) of the capacitor.

The design is also dependent on design rules imposed for example by the technology employed, such as the spacing between the bars or the width of the bars.

Starting from the design parameters, the configuration of the lower metallization levels, for example the metallization levels M₁ to M₅, is generated, by using a mathematical model tending to determine, notably, the number of bars or fingers in each of the first and second directions X and Y.

Using these parameters of the capacitor, the design parameters and the design rules, the design of the metallization levels M₆ and M₇ is then carried out.

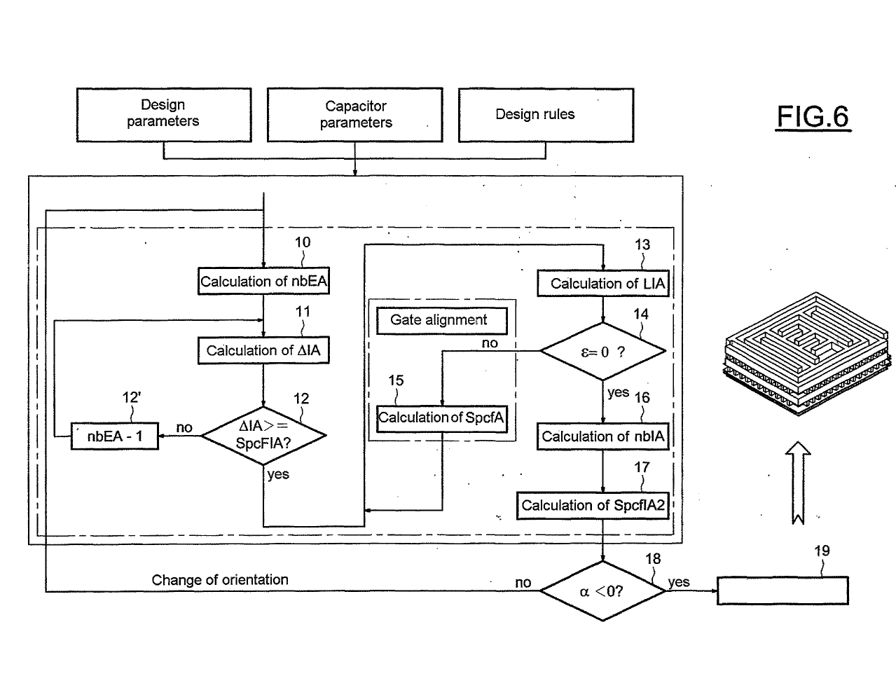

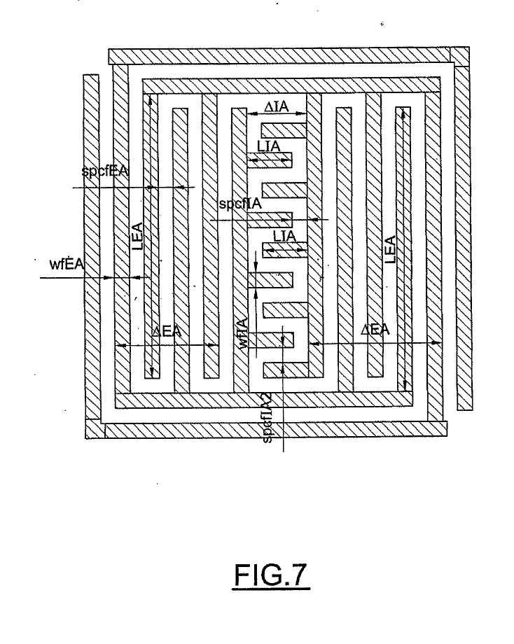

Referring to FIGS. 6 and 7, this design phase essentially consists in determining the spacing between the bars so as to be able to create lateral extensions while taking into account the spacing required between the bars and, in particular, the spacing required between the lateral extensions of one of the bars and an opposing branched bar.

In the design of the metallization levels with branched bars, here the levels M₆ and M₇, during a first step 10, the number of bars nbEA for each upper electrode is calculated. The additional electrodes of the levels M₆ and M₇ have an identical structure and the same orientation. The calculations implemented are therefore applicable to both layers.

In order to calculate the number of bars nbEA, the following calculations are carried out:

wfEA=Width min DRM(M6,M7) (1)

spcfEA=Spacing min DRM(M6,M7) (2)

$$nbEA = trunc ( \frac{nbx \cdot wf + ( nbx - 1 ) \cdot spcf}{2 ( wfEA + spcfEA} ) \qquad ( 3 )$$

in which:

Width min DRM denotes the minimum width of metal line achievable in fabrication;

Spacing min DRM denotes the minimum spacing between 2 metal lines achievable in fabrication;

trunc denotes the truncation operation, in other words the integer part;

wfEA denotes the width of the bars;

spcfEA denotes the space between the bars;

nbx and spcf respectively denote the number of bars and the spacing between bars in the lower metallization levels.

In the following step 11, the calculation of the spacing or distance ΔIA between branched bars is carried out, as illustrated in FIG. 7, starting from the following relationship:

ΔIA=nbx·wf+(nbx−1)·spcf−2[nbEA·wfEA+(nbEA−1)·spcfEA] (4)

It should then be verified in the following step 12 that the spacing between the branched bars is large enough to incorporate branches, taking into account the spacing required between the branched bars spcfIA.

If such is not the case, in other words if ΔIA is less than the minimum value required spcfIA, one bar is removed for each comb or, in other words, one pair of bars is removed for each metallization level M₆ or M₇ (step 12′).

On the other hand, if such is the case, the calculation of the length of the branched bars and of their number is then carried out. Thus, the length LIA of the branched bars is firstly calculated according to the following equation:

$$LIA = \frac{Δ IA - spcfIA}{2} \qquad ( 5 )$$

In the following step 14, the spacing between the bars is adapted to the technology and in particular to the gate pitch.

For this purpose, a parameter ε is calculated according to the following equation:

$$ɛ = nbx \cdot f + ( nbx - 1 ) \cdot spcf - 2 \cdot [ nbEA \cdot wfA + ( nbEA - 1 ) \cdot spcfA ] + LIA + \frac{spcfA}{2} \qquad ( 6 )$$

If it is observed during this step 14 that the value of this parameter ε is non-zero, in the following step 15, a new spacing spcfA calculation is carried out according to the following equation:

$$spcfA = \frac{nbx \cdot wf + ( nbx - 1 ) \cdot spcf - 2 \cdot ( nbEA \cdot wfA - LIA )}{2 \cdot nbEA} \qquad ( 7 )$$

Subsequently, the procedure returns to the preceding step 13 in order to carry out a new calculation of the finger length.

When it has been verified that the parameter ε is equal to zero, in the following step 16, the number of branches nbIA is then calculated according to the following equation:

$$nbIA = trunc ( \frac{LEA}{wfA + spcfA} ) \qquad ( 8 )$$

Subsequently, in the following step 17, the spacing spcfIA is calculated between the branched bars, or, in other words, the distance between the branches of the branched bar of one of the combs and of the branched bar of the other comb, according to the following relationship:

$$spcfIA 2 = \frac{LEA - nbIA \cdot wfA}{nbIA - 1} \qquad ( 9 )$$

A parameter α is then calculated which corresponds to the difference between, on the one hand, the number of branches according to a first configuration according to which these branches extend in a first direction X of the integrated circuit multiplied by their length and, on the other, the number of branches according to a second configuration according to which these branches extend in a second direction Y of the integrated circuit multiplied by their length (step 18).

In other words, the following parameter α is calculated:

α=nbIA_{—}xdir·LIA_{—}xdir−nbIA_{—}ydir·LIA_{—}ydir (10)

If the value of this parameter α is negative, a change of orientation is made, then the aforementioned steps 10 to 17 are repeated but changing the orientation of the configuration in such a manner as to arrive at a positive or zero parameter α.

In the following step 19, the calculated value of the various parameters is then retained allowing the bars and branches to be described such as the number, the length, the width and the spacing between the bars.

It will be noted that, in the embodiment just described, the upper metallization levels, here the metallization levels M₆ and M₇, each comprise patterns comprising a pair of interleaved combs.

It will however be noted that the aforementioned configuration is in no way limiting, and other variants may also be envisaged.

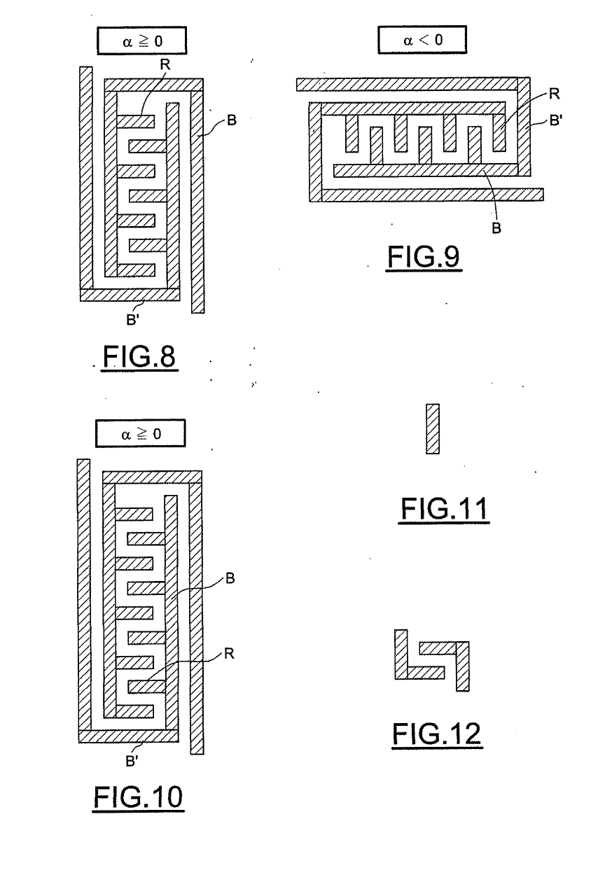

Referring first of all to FIGS. 8 and 9, and as previously indicated, depending on the calculated value of the parameter α, it is possible to change the orientation of the bars and of their branches.

It is thus possible, as can be seen in FIG. 8, to orient the branches in such a manner that they are aligned parallel to a first direction X and to orient the bars such that they are aligned parallel to a second direction Y of the integrated circuit. In contrast, the internal branches may be oriented in the second direction Y and the bars in the first direction X (FIG. 9).

Referring to FIG. 10, it is also possible to modify the length of the bars and, similarly, the number of internal branches.

Thus, as can be seen in FIGS. 11 and 12, it is possible to only provide a single branch and a single bar in the upper metallization levels or, as a variant, to only provide a single pair of interleaved bars each comprising only one branch.

However, when several bars comprising one or more branched bars are provided, the latter are preferably disposed in the center, whereas the non-branched bars are disposed on either side of the branched bars.

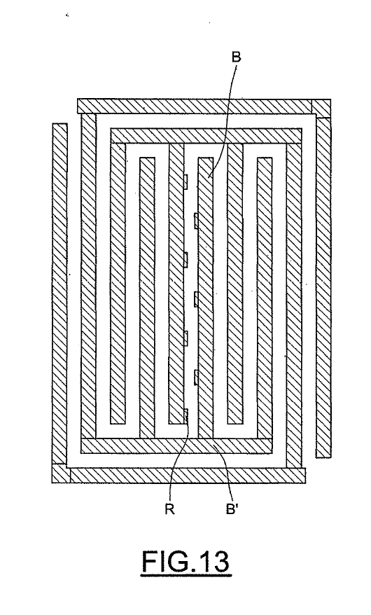

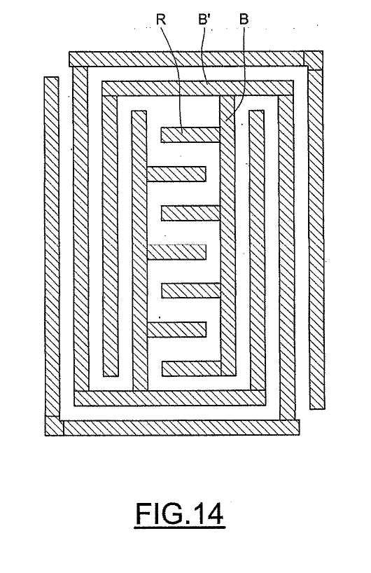

Similarly, as previously indicated, the length of the branches can vary depending on the design constraints (FIGS. 13 and 14).

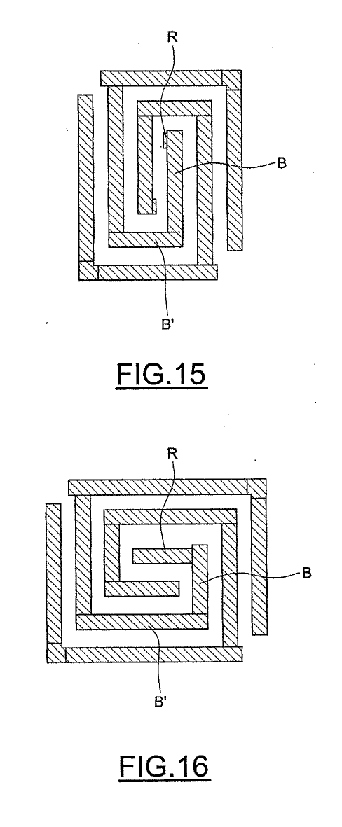

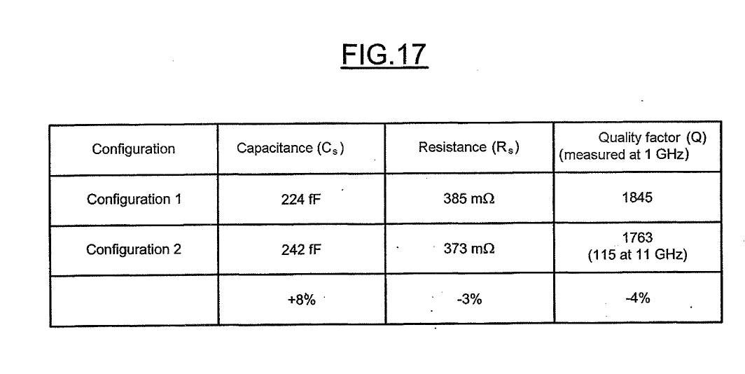

Referring to FIGS. 15 and 16, it is also possible to extend a lateral bar of each comb with additional bars, the electrodes then taking the form of two intertwined spirals.

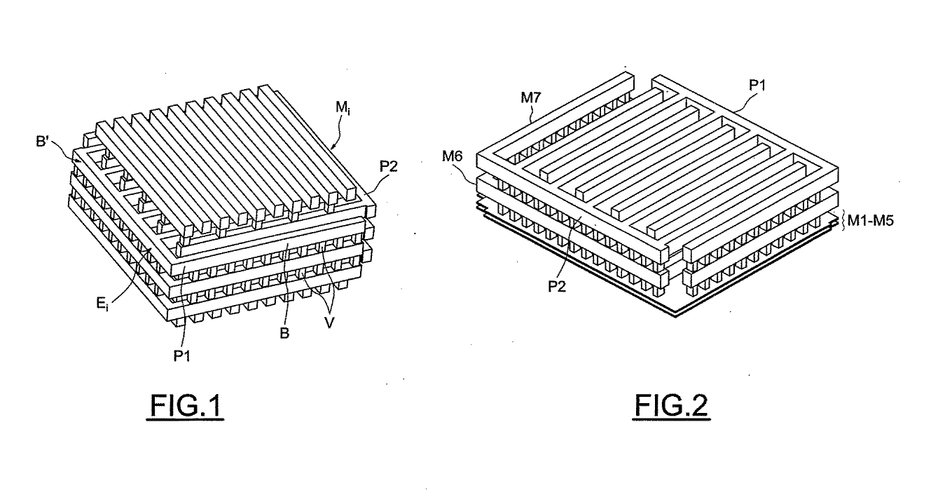

Referring finally to FIG. 1, it has been observed that the branched bar configuration allowed the value of the capacitance of the capacitor to be very significantly increased, for a substantially constant value of resistance and quality factor (configuration 2 with respect to a conventional configuration (configuration 1)).

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1-17. (canceled)

18. A three-dimensional capacitor, comprising:
a multilayer of superposed electrodes formed within respective metallization levels of an integrated circuit;
at least two additional superposed electrodes formed on top of said multilayer, the additional electrodes each comprising an assembly of at least one bar aligned in a first direction;
wherein at least one part of said bars comprises branches extending in a second direction;
wherein the bars of each additional electrode comprise a pair of identical matched and interleaved patterns each comprising a first assembly of at least one bar aligned parallel to each bar of another pattern in the first direction and a second assembly of at least one bar aligned parallel to the bars of the second assembly of bars of the other pattern in the second direction.

19. The capacitor according to claim 18, wherein the branches are composed of fingers extending perpendicular to the bars.

20. The capacitor according to claim 18 wherein the additional electrodes comprise rectilinear non-branched end bars and branched central bars provided between the end bars.

21. The capacitor according to claim 18, wherein the bars of one of the additional electrodes are aligned parallel to the bars of the other additional electrode.

22. The capacitor according to claim 18, wherein the branches extend from the central bars of the first assembly of bars.

23. The capacitor according to claim 18, wherein the bars of the first assembly of bars are formed from one of the bars of the second assembly of bars.

24. The capacitor according to claim 18, wherein the electrodes of the multilayer of electrodes each comprise a pair of identical and interleaved patterns each comprising a first assembly of bars aligned parallel to each bar of another pattern in one of the said first or second directions and a second assembly of bars aligned parallel to each second bar of the other pattern in the other of the said first or second directions.

25. The capacitor according to claim 24, wherein the patterns of each electrode of the multilayer of electrodes are oriented in a direction different from that of the patterns of an electrode immediately below or above.

26. A method for designing a three-dimensional capacitor comprising a multilayer of superposed electrodes formed within respective metallization levels of an integrated circuit, and comprising at least two additional superposed electrodes formed on top of the said multilayer in such a manner that the additional electrodes each comprise an assembly of at least one bar aligned in a first direction and that at least one part of the bars comprises branches extending in a second direction, the method comprising:
calculating a number of bars for each additional electrode;
calculating an available distance for the branches; and
adapting the number of bars in such a manner as to obtain an available length for the branches greater than a minimum distance required between the bars.

27. The method according to claim 26, comprising determining a number of branches based on the length of the bars, on the width of the branches and on the spacing between neighboring branches, and determining a length of the branches based on the distance between the bars and on the minimum spacing required between the bars.

28. The method according to claim 27, wherein the width of the branches is set equal to the width of the bars.

29. The method according to claim 26, comprising:
calculating the number of bars as a function of the width of the bars and of the spacing between the bars;
calculating the spacing between the branched bars;
comparing the spacing calculated with a minimum value of spacing required between a branch and a neighboring branched bar; and
modifying the number of bars calculated in such a manner as to obtain a spacing value greater than a minimum required value.

30. The method according to claim 29, further comprising adapting the spacing required between the bars prior to the calculation of the length of the branches.

31. The method according to claim 26, further comprising calculating a distance between two neighboring branches.

32. The method according to claim 31, further comprising orienting the bars in such a manner as to obtain a maximal total length of the branches.

33. The method according to claim 32, comprising calculating a difference between, in a first instance, the length of the branches for a first configuration in which the bars are aligned in a first direction, multiplied by the number of branches, and calculating a difference between, in a second instance, the length of the branches for a second configuration in which the bars are aligned in a second direction perpendicular to the first direction, multiplied by the number of branches, and further comprising choosing between the first and second configurations depending on the result of the calculation of said difference.

34. A three-dimensional capacitor, comprising:
a multilayer of superposed electrodes formed within respective metallization levels of an integrated circuit;
at least two additional superposed electrodes formed on top of said multilayer, the additional electrodes each comprising an assembly of at least one bar aligned in a first direction and having branches extending in a second direction;
wherein the bars of each additional electrode form a matching interleaved pair of patterns each comprising a first assembly of at least one bar aligned parallel to each bar of another pattern in the first direction and a second assembly of at least one bar aligned parallel to the bars of the second assembly of bars of the other pattern in the second direction.

35. Apparatus comprising:
a metallization level of an integrated circuit, the metallization level being one of a multilayer structure defining a three-dimensional capacitor;
wherein the metallization level comprises:
a first electrode; and
a second electrode;
wherein each of the first and second electrodes comprises a rectilinear branched structure including:
a first set of branches extending in a first direction from a bar which extends in a second direction perpendicular to the first direction; and
a second set of branches extending in the second direction from at least one of branch within the first set of branches;
wherein the rectilinear branched structures of the first and second electrodes comprise a pair of identical matched and interleaved patterns.

36. The apparatus according to claim 35, wherein each additional electrode comprises a non-branched end bar extending along at least one edge of the capacitor, the end bar being connected to the rectilinear branched structure of the electrode.

37. The apparatus according to claim 35, wherein the first set of branches include a central branch, and wherein the second set of branches extends from the central branch of the first set of branches.
